(19) United States
(12) Patent Application Publication
(10) Pub. No.: US 2026/0204931 A1
(43) Pub. Date: Jul. 16, 2026

(54) BATTERY CELL IMBALANCE DETECTION SYSTEM DURING BATTERY DISCHARGING

(71) Applicant: Tesla, Inc., Austin, TX (US)

(72) Inventors: Michael Kuss, Boulder, CO (US); Frederic Marangone, Louisville, CO (US); Orion Andrew King, Austin, TX (US)

(21) Appl. No.: 19/139,293

(22) PCT Filed: Jan. 9, 2024
(86) PCT No.: PCT/US2024/010911

§ 371 Date: Jun. 13, 2025

Related U.S. Application Data
(60) Provisional application No. 63/479,320, filed on Jan. 10, 2023.

(51) Int. Cl. H02J 7/63; H01M 10/44; H02J 7/52; H02J 7/82; H02J 7/90; H02J 7/96

(52) U.S. Cl. CPC H02J 7/63; H01M 10/441; H02J 7/52; H02J 7/82; H02J 7/933; H02J 7/96; H02J 7/975

(57) ABSTRACT

The present disclosure generally relates to systems and methods for monitoring battery cell imbalance during battery discharging. A battery can include a plurality of battery cells. During the battery discharging process, when the battery capacity reaches the criteria, a battery discharging device retrieves energy and/or voltages of the battery and determines the change of voltages corresponding to the change of the energy for the battery. The determined results can be compared to battery discharging reference data to determine battery cell imbalance. The battery discharging device may terminate the battery discharging process by detecting the battery cell imbalance.

### CROSS-REFERENCE TO RELATED APPLICATION

This application claims priority to U.S. Provisional Patent Application No. 63/479,320 titled “BATTERY CELL IMBALANCE DETECTION SYSTEM DURING BATTERY DISCHARGING” and filed on Jan. 10, 2023, the disclosure of which is hereby incorporated herein by reference in its entirety.

### TECHNICAL FIELD

Embodiments of the present disclosure relate to battery cell technologies. More specifically, embodiments of the present disclosure relate to detecting battery cell imbalance.

### BACKGROUND

A battery discharging device may be used to measure aspects of, or otherwise characterize, battery cells that form a battery. More specifically, the battery discharging device can be connected to the battery and measure the battery's output voltage and/or current. The battery discharging device can also be connected to a load. The load is utilized as a repository for the energy extracted from the battery. For instance, by connecting the battery discharging device to both the battery and the load, it can facilitate the discharge process by channeling the energy from the battery into the load.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIG. 1 is a block diagram of a battery discharging system that includes one or more batteries, a battery discharging device, and a battery management service.

FIG. 2 is an illustrated example of a battery installed in an example vehicle.

FIG. 3A is a block diagram of an illustrative battery management system.

FIG. 3B is a block diagram of an illustrative battery discharging device.

FIGS. 4A-4B are block diagrams illustrating the detail of discharging a battery by monitoring battery cell imbalance.

FIG. 5 is a flow diagram illustrative of a routine for discharging a battery.

### DETAILED DESCRIPTION

Although certain preferred embodiments and examples are disclosed below, the inventive subject matter extends beyond the specifically disclosed embodiments to other alternative embodiments and/or uses and modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations, in turn, in a manner that may be helpful in understanding certain embodiments; however, the order of description should not be construed to imply that these operations are order-dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

The present disclosure describes techniques to detect battery cell imbalance during a battery discharging process, where the battery includes a multitude of battery cells. Illustratively, one or more aspects of the present disclosure correspond to monitoring the battery's voltage and/or current changes in real-time or near real-time during the battery discharging process and aborting the discharging by detecting battery cell imbalances. In addition, in some embodiments, the battery cell imbalances can be detected by monitoring the electrical attributes of the battery without monitoring the electrical attributes of individual battery cells included in the battery.

Generally, rechargeable batteries (e.g., a storage battery or a secondary battery) can be used in a variety of applications, such as personal electrical devices, vehicles, electric vehicles, or any electrical device that requires electrical power. The rechargeable batteries are configured to be charged or discharged into a load. The charging and discharging can be generally referred to as a charging cycle, and rechargeable batteries can have many charging cycles during the lifetime of the rechargeable batteries. The charging and discharging of a battery can be based on the movement of ions within the battery. For example, a lithium-ion battery can utilize lithium ions that move between the anode and cathode of the battery through liquid electrolytes. The lithium-ion is merely an example, and a variety of ions such as lead-acid, zinc-air, nickel-cadmium (NiCd), nickel-metal-hydride (NiMH), lithium iron phosphate (LiFePO4), and lithium-ion polymer (Li-ion polymer) can be used based on a specific application.

Rechargeable battery cells can be formed into a battery based on the battery capacity requirements of specific applications. For example, if a load requires 10 kwh, 10 battery cells, where each cell has a 1 kwh capacity, can be packed (e.g., connected in series) as a battery. Thus, each battery can include multiple battery cells based on the battery capacity required by a load (e.g., based on specific applications). This battery, however, can be vulnerable to the risk of fire. For example, even though the battery may not be connected to a load, the ions in each cell may be moved in reaction to a connection to other cells. In this example, the ions in specific cells may move in these specific cells more actively than in other cells. This movement of the ions (e.g., imbalance movement) in certain cells can cause a battery cell imbalance. As may be appreciated, such a battery cell imbalance can generate heat within the battery and may be able to cause a fire in the battery. To reduce this heating and associated risk caused by battery cell imbalance, the battery may be discharged when not in use (e.g., stored for a period of time). For example, the International Air Transportation Association (IATA) provides strict guidelines for transporting batteries, including a requirement for maintaining the battery's energy when transporting the batteries. For example, the IATA requires the battery's (Lithium-ion) state of charge to be less than a threshold (e.g., 30%) of its rated capacity to be transported. In another example, in the case of battery service or recycling process, where the process requires the battery to be removed from its load, the battery needs to be discharged to minimize the fire risk. In other examples, when the battery installed in an electric vehicle requires service, the battery may need to be discharged.

Traditionally, battery discharging can be performed by connecting a discharging load to the battery. For example, a discharging load can be connected to the battery and can draw current from the battery, resulting in the battery discharging. During this discharging, a battery cell imbalance can occur which causes heat to be generated. For example, one or more battery cells in the battery can be discharged faster than other of the battery cells. These battery cells can generate heat due to an excessive current flow into the discharging load. However, the traditional techniques cannot detect the battery cell imbalance until the battery cells generate heat. Thus, the traditional techniques can have a high risk of causing fire during the discharging process.

To address at least a portion of the above-described deficiencies, the disclosed technology enables monitoring and/or detecting battery cell imbalance during the battery discharging process. According to one or more embodiments of the present disclosure, a battery discharging device may perform the battery discharging by monitoring battery voltage changes with respect to the amount of battery discharge, such as a metric of voltage change with respect to energy change during the battery discharging (e.g., dV/dQ, where V is voltage and Q is energy or charge). The battery discharging device can measure battery voltage and/or current during the discharging process. In some examples, the battery voltage measurement is provided by a battery discharging device connected to the battery. The battery discharging device can also monitor battery energy (e.g., discharged energy or remaining energy of the battery) during the discharging process. The battery discharging device can detect the battery cell imbalance based on the measured battery voltage and/or current with respect to the battery energy change. For example, the battery discharging device can determine a metric of voltage change (e.g., metric of voltage change with respect to energy change) of the battery with respect to the energy change during the discharging process. The determined voltage change of the battery with respect to the energy change can be compared with battery discharging reference data (e.g., stored in or otherwise accessible to the battery discharging device). The battery discharging reference data can include various reference battery voltages with respect to the battery energy. For example, if the voltage of the battery is dropped from 10V to 7V, the reference data can provide the reference battery energy change, such as 100 Wh to 70 Wh that correspond to the 10V and 7V. Then, the measured voltage change (by the discharging device or an outside device in communication with the discharging device) with respect to the energy change of 100 Wh to 70 Wh can be compared with the reference battery energy corresponding to 10V and 7V. Further, in this example, if the battery voltage changes slowly or rapidly (e.g., relative to the reference battery voltage changes with respect to the energy changes included in the reference data), with respect to the battery energy changes during the battery discharging process, the battery discharging device may detect the battery cell imbalance and abort the discharging process. Thus, in some embodiments the battery discharging reference data my indicate a metric (e.g., dV/dQ) which may be compared to the measured metric described above. If the measured metric is greater than a threshold different than the reference data an imbalance may be detected.

Illustratively, the battery discharging device may measure the battery's voltage and/or current by connecting to the battery. For example, the battery discharging device can include an interface to electrically connect the output terminals of the battery. In some embodiments, the battery discharging device can include a processor to determine the battery voltage and/or current of the battery. The battery discharging device can also determine the energy (e.g., remained battery energy or discharged energy) associated with the battery during the battery discharging. The battery discharging device may receive battery discharging reference data from an external source, such as a network service. Then, the battery discharging device can determine the battery cell imbalance by comparing the measured battery's voltage and/or current with the battery discharging reference data.

One aspect of the present disclosure relates to monitoring the battery cell imbalance during the battery discharging process. In this aspect, the battery discharging device can measure the voltage of the battery. The voltage of the battery can be measured in real time or near real time and utilized as input data to the battery discharging device. In some embodiments, the battery discharging device also stores battery discharge reference data in a memory of the battery discharging device. Alternatively, the battery discharging device can receive the battery discharging reference data from a battery management server. The battery discharging reference data may include the battery energy level that corresponds to a battery output voltage (e.g., a measured voltage). For example, the battery discharging reference data may indicate voltages that each correspond to a specific battery energy (e.g., non-limiting examples of remaining energy, remaining capacity, discharged energy, or discharged capacity). Thus, a change in the battery voltage (metric of change in the battery voltage) can be determined based on two values of the battery energies, and this change can be determined as a metric and utilized as the reference data. In some cases, the battery discharging device can monitor the battery cell imbalance by comparing the reference data with the measured data from the battery. For example, the battery discharging device may measure two battery voltages at two different times, such that an initial time when the discharging is initiated and a second time when the battery is discharged to a certain percentage relative to the initial energy. For example, the initially measured voltage (e.g., initial voltage) can indicate the output battery voltage of 10V, whereas the second measured voltage (e.g., measured voltage during the discharging or measured voltage when the battery is discharged to certain levels) indicates the output battery voltage of 5V. The battery discharging device can also determine the battery energy corresponding to the measured voltages, such that 100 Wh and 50 Wh correspond to the 10V and 5V, respectively. In this example, the voltage changes in terms of the energy changes can be determined as 0.1 V/Wh. Then, the battery discharging device can access the battery discharging reference data and determine the reference voltage change with respect to energy change, such as 0.2 V/Wh (this value can be derived in an example that references voltage changes (10V to 5V) with respect to energy change (70 Wh to 45 Wh), respectively). In this example, the 0.1 V/Wh is less than the reference value of 0.2 V/Wh, and the cell imbalance can be detected. In some embodiments, the battery discharging reference data can provide the reference energy changes in a single value or range. These reference energy changes can be utilized as a threshold.

Another aspect of the present disclosure relates to the frequency of the detection of the battery cell imbalance during the battery discharging process. In this aspect, the battery discharging device may detect a triggering event (e.g., threshold), initiate measuring the output voltage of the battery, and determine whether the battery cell imbalance has occurred. The triggering event can utilize criteria that can trigger the battery discharging device to analyze whether the battery cell imbalance has occurred. In some examples, the criteria can be based on the discharging level of the battery. For example, if the battery is discharged about 10% of its initial energy of the battery (or the rated capacity of the battery), the battery discharging device may initiate the battery cell imbalance detection process. Throughout the present disclosure, the terms, such as change of voltage with respect to energy change, can refer to a metric of change of voltage with respect to energy change. Even though the present disclosure refers to a metric of the change of voltage with respect to energy change, the metric can also be a change of energy with respect to voltage change.

Although aspects of the present disclosure will be described with regard to illustrative network components, interactions, and routines, one skilled in the relevant art will appreciate that one or more aspects of the present disclosure may be implemented in accordance with various environments, system architectures, customer computing device architectures, and the like. Similarly, references to specific devices, such as a battery, can be considered to be general references and not intended to provide additional meaning or configurations for the individual battery. Still, further, illustrations and exemplary configurations are not intended to be limited and should not be construed as limiting the scope of the present disclosure. Additionally, the examples are intended to be illustrative in nature and should not be construed as limiting. Furthermore, the energy, as used herein, can generally refer to energy stored in the battery or battery capacity that the amount of energy that can be extracted from the battery, and the like.

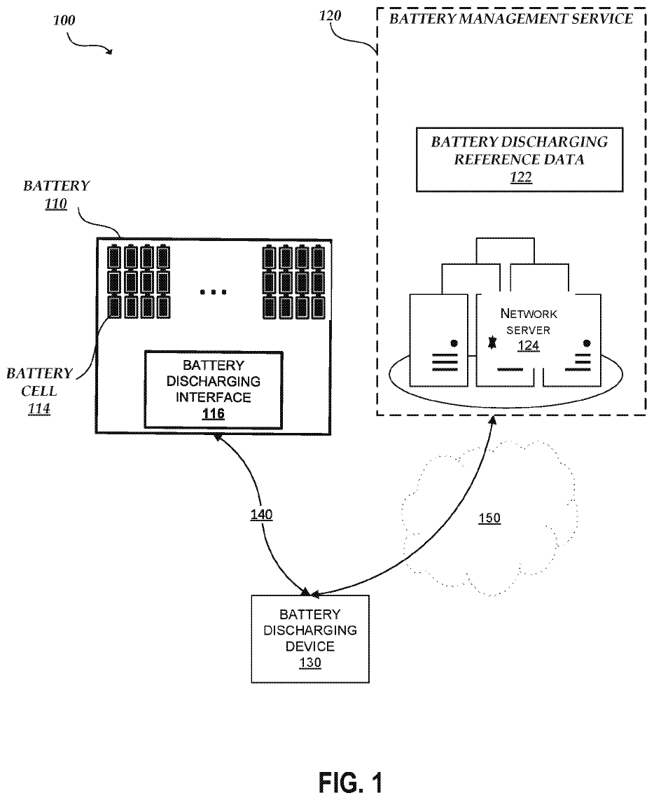

FIG. 1 depicts a block diagram of an embodiment of the system 100. The system 100 can include a network 140, the network connecting at least one battery discharging device 130, and a battery 110. Illustratively, the various aspects associated with the battery 110 can be implemented as one or more components that are associated with one or more functions or services. The components may correspond to software modules implemented or executed by the battery discharging device 130, which may be separate stand-alone devices. The system 100 can also include a network 150, the network connecting the battery discharging device 130, and a battery management service 120. Illustratively, the various aspects associated with the battery management service 120 can be implemented as one or more components that are associated with one or more functions or services. Accordingly, the components of the battery management service 120 should be considered as a logical representation of the service.

Network 140, as depicted in FIG. 1, can connect the devices and modules of the system. In some embodiments, the battery 110 and the battery discharging device 130 are connected via the network 140. In these embodiments, the network 140 can be a wired communication network, such that the battery discharging device 130 and the battery 110 are connected via wired communication using any one of the commercially available wired communication standards. In some embodiments, the network 140 is a high voltage cable.

Network 150, as depicted in FIG. 1, can connect one or more battery discharging device 130, and the battery management service 120. The network 150 can comprise any combination of wired and/or wireless networks, such as one or more direct communication channels, local area network, wide area network, personal area network, and/or the Internet. In some embodiments, the network 150 may include one or more wireless networks, such as a Global System for Mobile Communications (GSM) network, a Code Division Multiple Access (CDMA) network, a Long-Term Evolution (LTE) network, 5G communications, or any other type of wireless network. Network 160 can use protocols and components for communicating via the Internet or any of the other aforementioned types of networks. For example, the protocols used by the network 160 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein. In some embodiments, wireless communication via the network 150 may be performed on one or more secured networks, such as communicating with encrypting data via SSL (e.g., 256-bit, military-grade encryption). The various communication protocols discussed herein are merely examples, and the present disclosure is not limited thereto.

The battery 110 in FIG. 1 can connect to the battery discharging device 130. In some embodiments, the battery 110 is a rechargeable battery (e.g., a storage battery or a secondary battery). In these embodiments, the battery 110 can be configured to be charged or discharged into a load. The charging and discharging can be generally referred to as a charging cycle, and the battery 110 can have many charging cycles during its lifetime. Variety types of batteries can be used, such as lead-acid, zinc-air, nickel-cadmium (NiCd), nickel-metal-hydride (NiMH), lithium iron phosphate (LiFePO4), and lithium-ion polymer (Li-ion polymer) type battery.

In some embodiments, the battery 110, as shown in FIG. 1, can include a multitude of battery cells 114. In some embodiments, one or more battery cell 114 or a multitude of battery cells 114 can be packed as a battery 110. The number of battery cells 114 within the battery 110 can be determined based on a specific application. The battery 110 shown in FIG. 1 is illustrated for example purposes. The battery 110 can include a multitude of battery cells 114 and can be packaged as an array of battery cells. The present disclosure does not limit the configuration or structure of the battery 110.

The battery 110 shown in FIG. 1 can include a battery discharging interface 116. In some embodiments, the battery discharging interface 116 can be configured to provide a physical interface to be connected with the battery discharging device 130 via the network 140. For example, the battery discharging interface 116 can electrically connect to the battery 110. In this example, the battery discharging interface 116 can be connected with the battery 110, and thus, the battery discharging interface 116 may provide an interface to the battery discharging device 130 that can measure the status of the battery 110. The states, for example, can include each battery's 110 energy, voltage, current, temperature, operating time, impedance, etc. In some embodiments, each battery 110 can include a battery discharging interface 116. In one embodiment, multiple batteries can use a single battery discharging interface 116. The battery 110 is merely a logical implementation, and the present disclosure is not limited thereto.

The battery discharging device 130, as shown in FIG. 1, can connect to the battery 110 via the network 140. In some embodiments, the battery discharging device 130 can discharge the battery 110 by draining the energy of each battery cell 114. In these embodiments, the battery discharging device 130 can be a discharging load, and the energy of the battery 110 can be drained into the load of the battery discharging device 130. The battery 110 can also be connected to an external discharging load (not shown in FIG. 1), and the battery discharging device 130 can monitor the battery states, such as the discharged battery energy and/or remaining battery energy, during the discharging process. In some embodiments, the battery discharging device 130 can include the battery discharging load. In these embodiments, the battery 110 can be discharged by draining its energy into the battery discharging device 130.

In some embodiments, the battery discharging device 130 may access the battery management service 120 to discover the battery discharging reference data 122. In these embodiments, the battery management service 120 can include the battery discharging reference data 122. The battery discharging reference data can provide a reference change of battery voltages, current, state of charge, etc., during the battery discharging process. For example, the battery discharging reference data can show proper battery energy in terms of battery voltage. In this example, the discharge rate can be determined based on the battery voltage change with respect to the battery's energy changes. Thus, the battery discharging device 130 can determine whether a battery cell imbalance has occurred based on the measured discharging rate in terms of measured voltages as compared to the battery discharging reference data. In some embodiments, the battery management service 120 can store the battery discharging rate, measured voltages, and/or the measured energy during its discharging process. The components of the battery management service 120 should be considered as a logical representation of the service, not requiring any specific implementation on one or more customer computing devices.

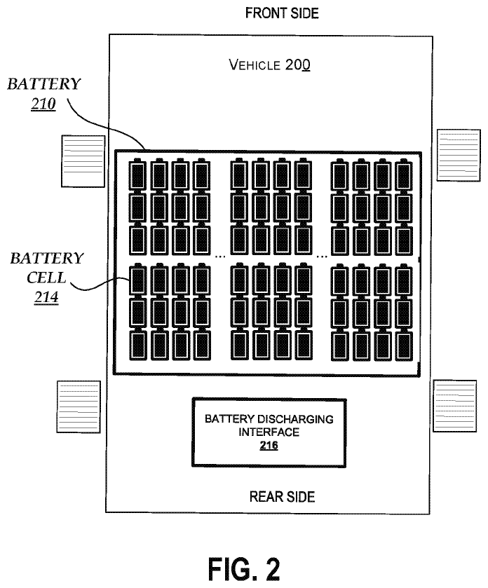

FIG. 2 illustrates an example of a battery installed in a vehicle. As shown in FIG. 2, the battery 210 can be installed in a vehicle 200. In some embodiments, the battery 210 includes a multitude of battery cells 214. The configuration of the battery 210 can be determined based on specific applications. The present disclosure does not limit the configuration of the battery. The vehicle 200 can include a battery discharging interface 216. The battery discharging interface 216 can be configured to provide an electrical interface to connect with the battery discharging device 130 via the network 140. For example, the battery discharging interface 216 can provide positive and negative terminals, where the battery discharging device 130 is connected to the terminals. In this example, the positive and negative terminals are connected with one or more of the battery cells 214. In some embodiments, the battery 210 can be connected to a battery discharging load (not shown in FIG. 2) to discharge the battery. In these embodiments, the battery discharging interface 216 can connect to the battery discharging device 130 (shown in FIG. 1). During the battery discharging process, the battery discharging device 130 can measure the current, voltage, and energy (e.g., remaining energy or discharged energy during the battery discharging) of battery 210 in real time or near real time.

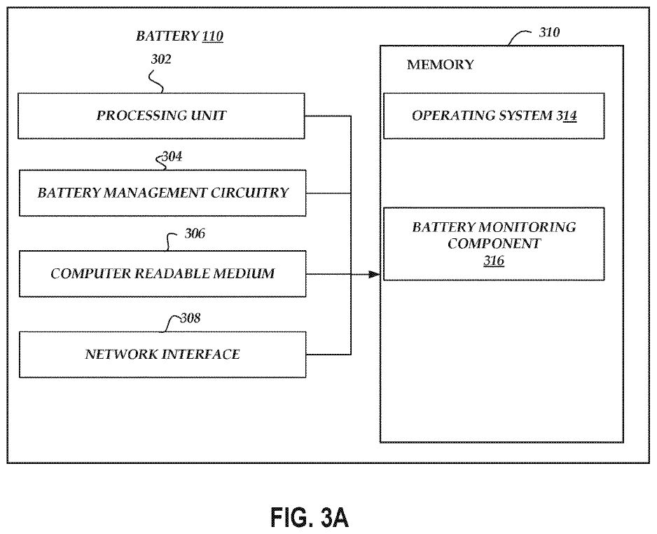

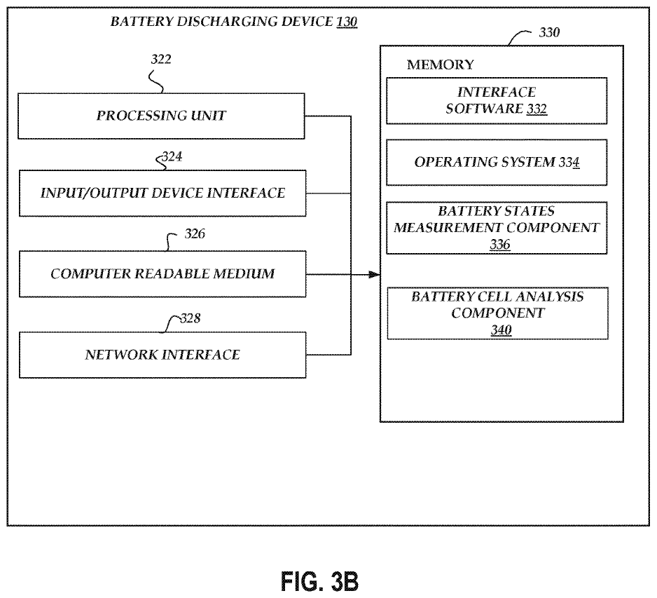

FIG. 3A depicts one embodiment of the architecture of an illustrative battery 110 (shown in FIG. 1). The battery 110 can be configured to monitor its states by measuring voltage and/or current, energy, etc. In some embodiments, the battery 110 measures the battery states of the battery 110. In these embodiments, the battery 110 can transmit the measured voltage, current, and/or energy of battery 110 to the battery discharging device 130 (shown in FIG. 1). The general architecture of the battery 110, as depicted in FIG. 3A includes an arrangement of computer hardware and software components that may be used to implement aspects of the present disclosure. As illustrated, the battery 110 includes a processing unit 302, a battery management circuitry 304, a computer-readable medium 306, and a network interface 308, all of which may communicate with one another by way of a communication bus. The components of the battery 110 may be physical hardware components or implemented as a software module,

The network interface 308 may provide connectivity to one or more networks, such as the network 140 of FIG. 1. The battery management circuitry 304 can be an electrical circuitry connected to the battery 110 and configured to measure the states of the battery 110. For example, the battery management circuitry 304 can be configured to measure the output voltage and/or current of the battery 110. The battery management circuitry 304 can also measure the states of the battery 110 in real time or near real time. The processing unit 302 may communicate to and from memory 310 and further provide output information for the battery states to the battery discharging device 130 via the network interface 308. In some embodiments, the battery 110 may include more (or fewer) components than those shown in FIG. 3A.

The memory 310 may include computer program instructions that the processing unit 302 executes in order to implement one or more embodiments. The memory 310 generally includes RAM, ROM, or other persistent or non-transitory memory. The memory 310 may store an operating system 314 that provides computer program instructions for use by the processing unit 302 in the general administration and operation of the battery 110. The memory 310 may further include computer program instructions and other information for implementing aspects of the present disclosure. For example, in one embodiment, memory 310 includes a battery monitoring component 316. In some embodiments, during a battery discharging process, when the battery capacity has reached certain criteria, the battery monitoring component 316 may instruct the processing unit 302 to measure the voltage and energy for the battery 110 and transmit the measured results to the battery discharging device 130. For example, during the battery discharging process, when 10% of the battery 110 capacity is discharged, the battery monitoring component 316 may instruct the processing unit 302 to measure the voltage of the battery 110 and transmit the measured voltage to the battery discharging device 130.

FIG. 3B depicts an example of the architecture of an illustrative battery discharging device 130 (shown in FIG. 1). The battery discharging device 130 can be configured to monitor the battery discharging by measuring the remaining energy or discharged energy of the battery, The battery discharging device 130 can also detect battery cell imbalance during the discharging process. In some embodiments, the battery discharging device 130 can determine the battery cell imbalance by utilizing the battery discharging reference data and the measured battery voltage and energy. In these embodiments, the battery discharging device 130 may measure the voltage and energy of the battery 110 when the discharging is initiated. After the discharging process is initiated, the battery discharging device 130 may detect a triggering event. The triggering event could be one or more thresholds or criteria and can be represented as percentage(s) of remaining battery energy with respect to the initial battery energy or the rated battery energy with full capacity. The battery discharging device 130 may also access the battery discharging reference data 122 stored in the battery management service 120. The battery discharging device 130 may also store the battery discharging reference data 122 in the memory of the battery discharging device 130. The battery discharging device 130 may analyze the measured voltage by comparing it with the battery discharging reference data to determine whether the battery cell imbalance has occurred. For example, the battery discharging device 130 may determine a change of measured voltage with respect to a change in the battery energy during the battery discharging process. These measured data can be compared to the corresponding battery energy change reference stored in the battery discharging reference data 122. The battery discharging reference data may include the battery voltages that each voltage corresponds to one or more energy levels of the battery. For example, the battery discharging reference data may indicate voltage and its corresponding energy levels or range of the energy levels. Thus, a reference change in the battery voltage with respect to the battery energy change can be determined. In some cases, the battery discharging device can monitor the battery cell imbalance by comparing the measured data (e.g., metric of measured battery voltage change with respect to the battery energy change) with the reference data (e.g., reference metric of battery voltage change with respect to the battery energy change). For example, the battery discharging device may measure two battery voltages at two different times, such as an initial time and a second time. The initial time can correspond to when the discharging is initiated, and the second time can be defined based on the percentage of the discharged energy of the battery relative to the initially measured energy. For example, the initially measured voltage can indicate the output battery voltage of 10V, whereas the voltage measured at the second time can indicate the output battery voltage of 5V. The battery discharging device can also determine the battery energy corresponding to the measured voltages, such that 100 Wh and 50 Wh correspond to the 10V and 5V, respectively. In this example, the voltage changes in terms of the energy changes can be determined as 0.1 V/Wh. Then, the battery discharging device can provide access to the battery discharging reference data and determine the reference energy change, such as 0.2 V/Wh (this value can be derived in an example that reference voltage changes (10V to 5V) with respect to energy change (70 Wh to 45 Wh), respectively ). In this example, the 0.1 V/Wh is lower than the reference value of 0.2 V/Wh, and the cell imbalance can be detected. In some embodiments, the battery discharging reference data can provide the reference energy changes in a single value or range. These reference energy changes can be utilized as a threshold.

The general architecture of the battery discharging device 130 may be depicted in FIG. 3B, includes an arrangement of computer hardware and software components that may be used to implement aspects of the present disclosure. As illustrated, the battery discharging device 130 may include a processing unit 322, an input/output device interface 324, a computer-readable medium 326, and a network interface 328, all of which may communicate with one another by way of a communication bus. The components of the battery discharging device 130 may be physical hardware components or implemented as a software module.

The network interface 328 may provide connectivity to one or more networks, such as the network 150 of FIG. 1. The input/output device interface 324 can be an interface connected to the battery 110. In some embodiments, the input/output device interface 324 is connected to the battery discharging interface 116. In these embodiments, the battery discharging device 130 measures the voltage transmitted by connecting with the battery via the battery discharging interface 116. In some embodiments, the battery discharging device 130 measures the voltage, current, state of charge, and energy of the battery 110 in real time and store the measured results as a data, and the data can be stored in the computer readable medium 326. In some embodiments, the battery discharging device 130 can include more (or fewer) components than those shown in FIG. 3B.

The memory 330 may include computer program instructions that the processing unit 322 executes in order to implement one or more embodiments. The memory 330 generally includes RAM, ROM, or other persistent or non-transitory memory. The memory 330 may store an operating system 334 that provides computer program instructions for use by the processing unit 322 in the general administration and operation of the battery discharging device 130. The memory 330 may further include computer program instructions and other information for implementing aspects of the present disclosure. For example, in one embodiment, the memory 330 includes interface software 332 to be connected with the battery discharging interface 116.

Additionally, the memory 330 includes a battery states measurement component 336 for measuring battery status. The states, for example, can include the battery's 110 energy, voltage, current, temperature, operating time, impedance, etc. In some embodiments, the battery states measurement component 336 measures the voltage of the battery 110 in real time or near real time. In these embodiments, the battery states measurement component 336 can process the measured voltages to detect battery cell imbalance during the discharging process. For example, during the battery discharging process, the battery states measurement component 336 may measure voltage for the battery 110 in real time or near real time. The battery states measurement component 336 may execute an instruction for the processing unit to store the measured voltages in the order of time sequence by categorizing for the battery 110. In some embodiments, during a battery discharging process, when the battery capacity is reached certain criteria, the battery states measurement component 336 may instruct the battery cell analysis component 340 to measure the voltage and energy for the battery 110. For example, during the battery discharging process, when 10% of the battery 110 capacity is discharged, the battery states measurement component 336 may instruct the battery cell analysis component 340 to analyze the battery cell to detect the imbalance.

The memory 330 may further include a battery cell analysis component 340 to detect a battery cell imbalance by analyzing the measured battery states of the battery 110. In some embodiments, the battery cell analysis component 340 performs the analysis based on certain criteria. In these embodiments, the criteria can be based on a remain capacity of battery. For example, if the criteria include a value or measure of 90% of remain energy from the initial battery energy (or the battery energy in full capacity, such that if the initial battery energy is 100 Wh, the analysis can be performed when the battery is discharged to 90 Wh), the battery cell analysis component 340 may initiate the analysis to determine whether battery cell imbalance is occurred. The analysis can include determining voltage change with respect to the energy change of the battery 110 during the discharging process. For example, when the battery 110 is discharged about 10% of its initial energy (e.g., 90% of energy remaining), such that the battery 110 is discharged from 100 Wh to 90 Wh, the battery cell analysis component 340 may store the battery measured voltage, such as the measured voltage of 10V at 90 Wh battery capacity. In this example, if the battery's measured voltage at 100 Wh is 20V, the change of voltage in terms of the change of battery energy can be 1 (e.g., 10V/10 Wh). The criteria can be set for more than one event, such that the criteria can be set as 5%, 10%, and 15% discharged from the initial energy or the energy with respect to the full capacity of the battery, and the analysis can be performed at each event. These criteria can be set with reference to the remaining energy, such as remaining energy of 95%, 90%, and 85% of the remaining energy. These criteria can be referred to as threshold values or triggering events. In addition, the these values are merely provided as examples, and the present disclosure is not limited to these numbers.

In some embodiments, the battery cell analysis component 340 can detect the battery cell imbalance by utilizing the battery discharging reference data 122 received from the battery management service 120 via the network 150. The battery discharging reference data 122 can include the battery energy range corresponding to the voltage range during the battery discharging process. In these embodiments, the battery discharging reference data 122 can be stored in the computer readable medium 326, and the battery cell analysis component 340 can execute an instruction for the processing unit 322 to compare the battery discharging analysis result with the battery discharging reference data 122 by accessing to the computer readable medium 326. Illustratively, when the battery capacity has reached the criteria (e.g., battery discharged to the criteria), the battery cell analysis component 340 may analyze each battery by executing an instruction for the processing unit to determine the voltage change corresponding to the battery's energy change. In this illustration, the determined voltage change in terms of the battery energy change can be compared to the battery discharging reference data. For example, if the battery is discharged from 90 Wh to 80 Wh and the measured voltage of the battery is changed from 12V to 7V, the measured voltage changes with respect to the battery energy change can be determined as 0.5 (e.g., 5V/10 Wh). In this example, the battery discharging reference data 112 may provide reference data, such as the change of battery voltage with respect to the battery energy change cannot exceed 0.8. Thus, the determined value of the battery voltage change with respect to the battery energy change, 0.5, can be within the range of the battery discharging reference data. If the determined voltage of the battery in terms of the battery energy change is not within the reference voltage range, the battery cell is imbalanced, and thus, the discharging process is terminated. For example, if the determined value of the battery voltage change corresponding to the battery energy change is 1, such that the battery voltage is changed from 12V to 2V, while the battery is discharged from 90 Wh to 85 Wh, the battery discharging device 130 may determine that there can be a battery cell imbalance.

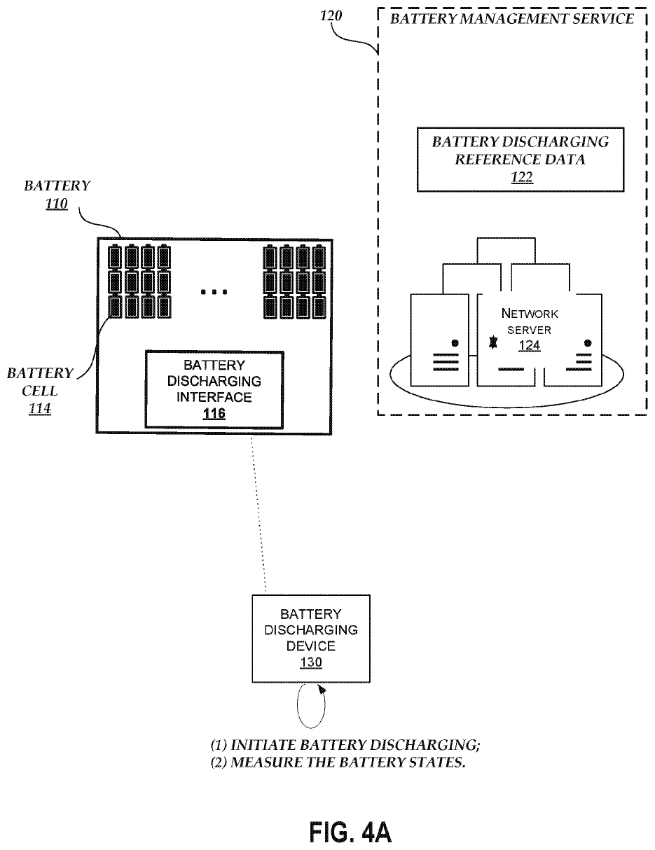

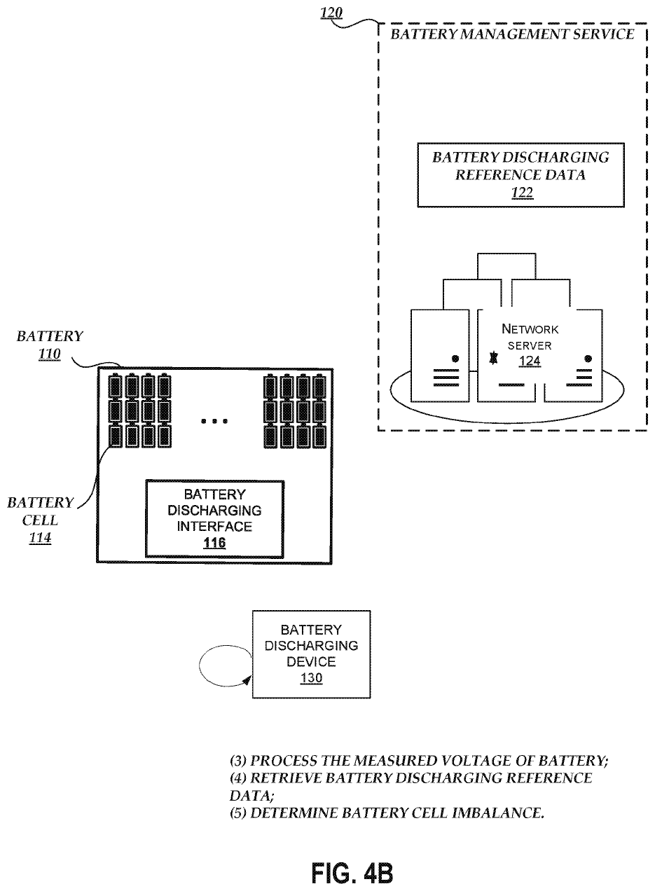

Turning now to FIGS. 4A-4B, illustrative interactions of the components of the system 100, as shown in FIG. 1, will be described. For the purpose of the illustration, it can be assumed that a battery 110 (shown in FIG. 1) includes a multitude of battery cells 114. The present disclosure is not intended to be limited to any particular type of battery, configuration, or number of battery cells.

With reference to FIG. 4A, an illustrative interaction of an initial process for detecting battery cell imbalance will be described. The interaction is illustrative. At (1), the battery discharging device 130 may initiate the battery discharging process. In some embodiments, the battery discharging device 130 can be connected to the battery, and the discharging process is initiated. In these embodiments, the battery discharging device 130 may include a discharging load. Thus, connecting the battery discharging device 130 to the battery 110 can cause the discharging process. For example, the battery discharging device 130 is connected to an output of the battery by connecting to the battery discharging interface 116 via network 140. In some embodiments, by controlling one or more functions of the battery discharging device 130, the output current of the battery is drained into the discharging load included in the battery discharging device 130. In some embodiments, the battery discharging device 130 can measure the initial battery voltage and energy when initiate the battery discharging process.

At (2), the battery discharging device 130 may measure the states of the battery 110. The states, for example, can include each battery's 110 energy, voltage, current, temperature, operating time, impedance, etc. In some embodiments, the battery discharging device 130 monitors the battery's energy changes by measuring the states of the battery in real time or near real time. For example, when the battery discharging device 130 is connected to the battery 110, the battery discharging device 130 measures the voltage of the battery 110. In one embodiment, the battery discharging device 130 measures the energy of the battery 110.

In some embodiments, the battery discharging device 130 may execute an instruction for the processing unit to store the measured voltages in the order of time sequence by categorizing each battery. In some embodiments, the battery discharging device 130 includes one or more criteria to initiate battery call imbalance analysis. For example, the criteria for triggering the battery cell imbalance analysis can be based on the discharging rate of the battery 110. In this example, the criteria can be 5%, 10%, or 15% of the discharging rate (e.g., discharged from the initial battery energy, such as remaining battery energy of 95%, 90%, or 85% with respect to the initial battery energy or full capacity of the battery energy, respectively), and the criteria trigger the battery cell imbalance analysis when the 5%, 10%, or 15% of the battery capacity is discharged. For example, if the initial battery energy is 100 Wh, the battery cell imbalance analysis can be triggered when the energy of the battery is discharged to 95 Wh, 90 Wh, and 85 Wh. These criteria and battery capacity are merely provided as examples, and the criteria and battery capacity can be determined based on specific applications.

In some embodiments, the battery discharging device 130 can detect one or more parameters related to the battery states, such as voltage, current, energy, temperature, etc., from the battery discharging interface 116. In one embodiment, a discharging load (not shown in FIG. 4A) is connected to the battery, and the battery discharging device 130 does not include the discharging load. In these embodiments, the battery discharging device 130 may monitor the battery discharging process by receiving one or more parameters related to the battery state from the battery discharging interface 116.

With reference to FIG. 4B, an illustrative interaction of the battery cell imbalance analysis for detecting battery cell imbalance will be described. The interaction is illustrative. At (3), the battery discharging device 130 processes the measured voltage (e.g., measured battery states at (2)) of the battery 110. In some embodiments, the measured voltage of the battery is processed corresponding to the battery energy and based on the measurement time sequence. For example, the energy of the battery can be listed in a time sequence, and a voltage measured corresponding to each of the listed energy can be mapped. Advantageously, by utilizing the measured voltages of the battery 110, a metric of change of measured voltage in terms of the change of the battery energy for the battery 110 can be determined. For example, if the battery energy is changed from 90 Wh to 80 Wh and the measured voltage of the battery is changed from 12V to 7V, the metric of measured voltage changes corresponding to the battery energy change can be determined as 0.5 (e.g., 5V/10 Wh).

At (4), the battery discharging device 130 may retrieve a battery discharging reference data 122 from the battery management service 120. The battery discharging reference data can be a graph showing voltage corresponding to the battery energy. The battery discharging reference data 122 can show the reference voltage change of a battery corresponding to the battery energy change during the battery discharging process. The battery discharging reference data can be varied based on battery properties, such as types of battery, number of cells, operating temperature, etc. In some embodiments, the battery discharging reference data can be provided as a threshold value of the change of the battery voltage in terms of the change of battery energy, such as the threshold value of 0.8. In some embodiments, the battery discharging reference data can be updated based on, for example, the characteristics of the battery (e.g., battery type), number of cells included in the battery, battery discharging environments (e.g., humidity, temperature, etc.), and the like. In one embodiment, the battery discharging device 130 can receive the battery discharging reference data from an external device.

At (5), the battery discharging device 130 can determine the battery cell imbalance by utilizing the battery discharging reference data. In some embodiments, the battery discharging device 130 determines the change of battery voltage in terms of the changing energy of the battery. This result can be compared with the battery discharging reference data. The battery discharging reference data can include a reference metric of voltage change with respect to energy change between the initial energy and the measured energy. For example, if the voltage and energy of a battery are dropped from 4V to 2V and from 90 Wh to 80 Wh, respectively, the determined result (the reference data) can be 0.2. This result can be compared to the battery discharging reference data, such that the voltage and energy of the reference battery during the discharging are dropped from 4V to 1V and from 90 Wh to 80 Wh. Thus, the metric of reference voltage change with respect to the energy change (between the initial energy and measured energy during the discharging process) is about 0.3. These two values, 0.2 and 0.3, are different. Thus, the battery cells within this battery have an imbalance. In another example, if the determined voltage of the battery with respect to the battery energy change is not within the corresponding reference voltage range, the battery cell is imbalanced, and thus, the discharging process is terminated. For example, if the determined value of the battery voltage change corresponding to the battery energy change is 1, such that the battery voltage is changed from 12V to 2V, while the battery is discharged from 90 Wh to 80 Wh, the battery discharging device 130 may determine that there can be a battery cell imbalance These values are merely provided as examples, and the real values can be determined based on specific applications. In some embodiments, the reference data can provide the metric range of reference voltage change with respect to energy change. The metric range can include the threshold range, such that even if the reference data (reference voltage change with respect to energy change) indicates 0.5, the threshold range can be +/−0.1, thus, the reference data can be between 0.4 and 0.6. Thus, if the measured metric (e.g., voltage change with respect to energy change) is between 0.4 and 0.6 no imbalance would be detected. These threshold ranges can be determined based on specific applications, and the present disclosure does not limit these threshold ranges.

In some embodiments, the battery discharging device 130 terminates the battery discharging process in detecting the battery cell imbalance. If the battery discharging device 130 does not detect the battery cell imbalance, the discharging process can be continued. For example, in response to determining that the metric of measured voltage change is different from the reference data, the discharging device can terminate the battery discharging. Otherwise, in response to determining that the metric of measured voltage change is different from the reference data, the discharging device can resume the battery discharging.

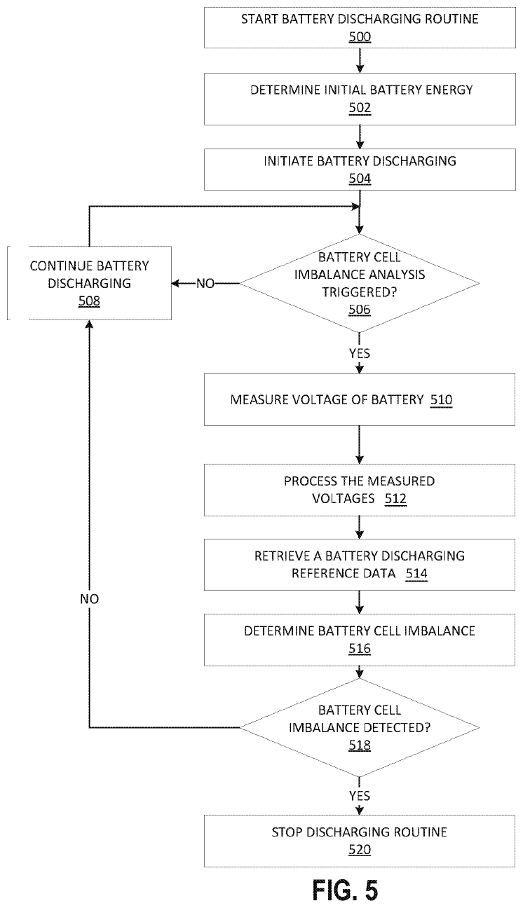

Turning now to FIG. 5, a routine for a battery discharging process by monitoring battery cell imbalance will be described. The routine is illustratively implemented by the battery discharging device 130.

At block 500 the battery discharging routine starts. Then at block 502, the battery discharging device 130 may determine the initial energy and voltage of the battery. In some embodiments, the battery discharging device may measure the initial energy and voltage of the battery by connecting to the battery via the battery discharging interface 116. In these embodiments, the battery discharging device 130 measures the initial energy and voltage of the battery before initiating the battery discharging process. In some embodiments, the battery discharging device 130 monitors the energy of the battery 110 by measuring the battery states in real time or near real time. The states, for example, can include each battery's 112 energy, voltage, current, temperature, operating time, impedance, etc. For example, when the battery discharging device 130 is connected to the battery 110 via the battery discharging interface 116, the battery discharging device 130 measures the state of the battery 110. The battery state can include a battery charge or energy, but the types of energy are not limited in this disclosure.

At block 504, the battery discharging device 130 may initiate the discharging process. In some embodiments, the battery discharging device 130 can be connected to the battery, and the discharging process is initiated. In these embodiments, the battery discharging device 130 may include a discharging load. Thus, connecting the battery discharging device 130 to the battery 110 can cause the discharging process. For example, the battery discharging device 130 is connected to an output of the battery, and by controlling one or more functions of the battery discharging device 130, the output current of the battery is drained into the discharging load included in the battery discharging device 130. In some embodiments, the battery discharging device 130 can connect to the battery discharging interface 116. In these embodiments, the battery discharging device 130 can receive one or more parameters related to the battery states, such as voltage, current, energy, temperature, etc., from the battery discharging interface 116. In one embodiment, a discharging load (not shown in FIG. 4A) is connected to the battery, and the battery discharging device 130 does not include the discharging load. In these embodiments, the battery discharging device 130 may monitor the battery discharging process by receiving one or more parameters related to the battery state from the battery discharging interface 116.

At block 506, the battery discharging device 130 determines whether a battery cell imbalance analysis is triggered. In some embodiments, the battery discharging device 130 includes one or more criteria that trigger a battery cell imbalance analysis. For example, the criteria for triggering the battery cell imbalance analysis can be based on discharging rate of the battery 110. In this example, the criteria can be 5%, 10%, or 15% (e.g., discharged from the initial battery energy, such as remaining battery energy of 95%, 90%, or 85% with respect to the initial battery energy or full capacity of the battery energy) of the discharging rate, and the criteria trigger the battery cell imbalance analysis when the 5%, 10%, or 15% of the battery capacity is discharged. For example, if the initial battery energy is 100 Wh, the battery cell imbalance analysis can be triggered when the energy of the battery is discharged to 95 Wh, 90 Wh, and 85 Wh. These criteria and battery capacity are merely provided as examples, and the criteria and battery capacity can be determined based on specific applications. If the battery cell imbalance is not triggered, the battery discharging device 130 continues discharging the battery at block 508.

At block 510, if the battery cell imbalance analysis is triggered, the battery discharging device 130 receives the voltage of the battery 110. In some embodiments, the battery discharging interface 116 measures the voltage of the battery 110 in real time during the discharging process and transmits the measured voltage to the battery discharging device. In these embodiments, the measured voltage can be at the battery 110 level. Thus, the battery discharging interface 116 measures the energy and voltage of each battery 110. In some embodiments, the battery discharging device 130 may store the measured energy and voltage in an internal storage medium.

At block 512, the battery discharging device 130 processes the measured voltage of the battery 110. In some embodiments, the measured voltage of the battery is processed based on the measurement time sequence. For example, the energy of the battery can be listed in a time sequence, and a voltage measured corresponding to each of the listed energy can be mapped. Advantageously, by utilizing the processed measured voltages of each battery 110, a change of voltage in terms of the change of the battery energy for each battery 110 can be determined. For example, if the battery energy is changed from 90 Wh to 80 Wh and the measured voltage of the battery is changed from 12V to 7V, the metric of measured voltage changes with respect to the battery energy change can be determined as 0.5 (e.g., 5V/10 Wh).

At block 514, the battery discharging device 130 may retrieve a battery discharging reference data 122 from the battery management service 120. The battery discharging reference data can be a graph showing voltage change corresponding to the battery energy change. The reference data can be represented as a metric of a reference metric of voltage change with respect to energy change between the initial energy and the measured energy. The battery discharging reference data 122 can show the voltage of a battery corresponding to the battery energy change during the battery discharging process. The battery discharging reference data can be varied based on battery properties, such as types of battery, number of cells, operating temperature, etc. In some embodiments, the battery discharging reference data can be provided as a threshold value of the change of the battery voltage in terms of the change of battery energy, such as the threshold value of 0.8. In some embodiments, the battery discharging reference data can be updated. In one embodiment, the battery discharging device 130 can receive the battery discharging reference data from an external device. The battery discharging device 130 can determine reference data that includes a reference metric of voltage change with respect to energy change between the initial energy and the measured energy. The battery discharging reference data can also include a multitude of reference voltages and a multitude of energy levels that each voltage corresponds to one or more of the energy levels

At block 516, the battery discharging device 130 can determine the battery cell imbalance by utilizing the battery discharging reference data. For example, the battery discharging device 130 can determine a voltage change that indicates voltage changes between the measured voltage and initial voltage with respect to the measured energy and the initial energy. In some embodiments, the battery discharging device 130 determines the change of battery voltage in terms of the changing energy of the battery. This result can be compared with the battery discharging reference data. For example, if the voltage and energy of a battery are dropped from 4V to 2V and from 90 Wh to 80 Wh, respectively, the determined result can be 0.2. This result can be compared to the reference data (e.g., from the battery discharging reference data), such that the reference data of the voltage and energy of the reference battery during the discharging are dropped from 4V (initial voltage) to 1V (measured voltage) and from 90 Wh (initial energy) to 80 Wh (measured energy). Thus, the reference voltage change with respect to the energy change is about 0.3. These two values, 0.2 and 0.3, are different. Thus, the battery cells within this battery have an imbalance. In another example, if the determined voltage of the battery in terms of the battery energy change is not within the corresponding reference voltage range, the battery cell is imbalanced, and thus, the discharging process is terminated. For example, if the determined value of the battery voltage change corresponding to the battery energy change is 1, such that the battery voltage is changed from 12V to 2V, while the battery is discharged from 90 Wh to 80 Wh, the battery discharging device 130 may determine that there can be a battery cell imbalance These values are merely provided as examples, and the real values can be determined based on specific applications. In some embodiments, the reference data can provide the metric range of reference voltage change with respect to energy change. The metric range can include the threshold range, such that even if the reference data (reference voltage change with respect to energy change) indicates 0.5, the threshold range can be +−0.1, thus, the reference data can be between 0.4 and 0.6. These threshold ranges can be determined based on specific application, and the present disclosure does not limit these threshold ranges.

Based on the determination of the battery cell imbalance, the battery discharging device 130 can manage the battery discharging. For example, at block 518, if battery cell imbalance is detected, the discharging routine is terminated at block 520. If the battery cell imbalance is not detected, the battery discharging routine is continued at block 508.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be fully automated via software code modules, including one or more specific computer-executable instructions executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic devices, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of customer computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable customer computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code that include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

What is claimed is:

1. A system for managing battery discharging based on a battery cell imbalance, the system comprising:
a battery including a plurality of battery cells; and
a battery discharging device connected to the battery, wherein the battery discharging device is configured to:
measure initial battery voltage and initial energy;
initiate battery discharging;
determine one or more criteria related to discharged energy of the battery; and
in response to determining that the battery is discharged to the criteria:
measure voltage and energy of the battery,
determine, by accessing battery discharging reference data, a reference data that includes a reference metric of voltage change with respect to energy change between the initial energy and the measured energy, wherein the battery discharging reference data includes a plurality of reference voltages and a plurality of energy levels that each voltage corresponds to one or more of the energy levels,
determine a metric of measured voltage change that indicates voltage changes between the measured voltage and the initial voltage with respect to the measured energy and the initial energy,
compare the metric of the measured voltage change with the reference data, and
manage the battery discharging based on a comparison result between the metric of the measured voltage change and the reference data.

2. The system of claim 1, wherein managing the battery discharging comprises:
in response to determining that the comparison result indicates that the metric of measured voltage change is the same as the reference data, resume the battery discharging; or
in response to determining that the comparison result indicates that the metric of the measured voltage change is different from the reference data, terminate the battery discharging.

3. The system of claim 1, wherein the battery discharging device includes a discharging load.

4. The system of claim 1, wherein the battery includes a battery discharging interface, and wherein the battery discharging device and battery are connected via the battery discharging interface.

5. The system of claim 1, wherein the reference data are stored in a memory of the battery discharging device.

6. The system of claim 1, wherein the battery discharging device comprises a memory to store results of the measurements of the voltage and discharged energy of the battery.

7. The system of claim 1, wherein the one or more criteria are defined based on percentages of discharged energy from the initial energy of the battery.

8. The system of claim 1, wherein the battery discharge is initiated by connecting the battery discharging device to a battery discharging interface of the battery.

9. The system of claim 1, wherein the reference data is updated based on temperature and/or humidity.

10. A battery discharging device to discharge a battery including a plurality of battery cells, the battery discharging device is configured to:
initiate discharging the battery;
measure initial battery voltage and initial energy;
determine one or more criteria related to discharged energy of the battery;
in response to determining that the battery is discharged to the criteria, measure voltage and energy of the battery;
determine, by accessing to a battery discharging reference data, a reference data that includes a reference metric of voltage change with respect to energy change between the initial energy and the measured energy, wherein the battery discharging reference data includes a plurality of reference voltages and a plurality of energy levels that each voltage corresponds to one or more of the energy levels;
determine a metric of measured voltage change that indicates voltage changes between the measured voltage and initial voltage with respect to the measured energy and the initial energy;
compare the metric of measured voltage change with the reference data; and
in response to determining that the comparison result indicates that the metric of measured voltage change is same as the reference data, resume the battery discharging, or
in response to determining that the comparison result indicates that the metric of measured voltage change is different from the reference data, terminate the battery discharging.

11. The battery discharging device of claim 10, wherein the battery discharging is initiated when the battery discharging device is connected to a battery discharging interface of the battery.

12. The battery discharging device of claim 10, wherein the battery discharging device includes a discharging load, and wherein battery energy is discharged to the load.

13. The battery discharging device of claim 10, wherein the one or more criteria are defined based on percentages of discharged energy from the initial energy of the battery.

14. The battery discharging device of claim 10, wherein the reference data is updated based temperature and/or humidity.

15. The system of claim 10, wherein the reference data are stored in a memory of the battery discharging device

16. A method of managing a battery discharging, the method comprising:
initiating discharge of the battery via a connection of the battery to a battery discharging device, wherein the battery includes a plurality of battery cells;
measuring initial battery voltage and initial energy;
determining one or more criteria related to discharged energy of the battery;
in response to determining that the battery is discharged to the criteria, measuring voltage and energy of the battery;
determining, by accessing to a battery discharging reference data, a reference data that includes a reference metric of voltage change with respect to energy change between the initial energy and the measured energy, wherein the battery discharging reference data includes a plurality of reference voltages and a plurality of energy levels that each voltage corresponds to one or more of the energy levels;
determining a metric of measured voltage change that indicates voltage changes between the measured voltage and initial voltage with respect to the measured energy and the initial energy;
comparing the metric of measured voltage change with the reference data; and
managing the battery discharging based on a comparison result between the metric of measured voltage change and the reference data.

17. The method of claim 16, wherein managing the battery discharging includes:
in response to determining that the comparison result indicates that the metric of measured voltage change is same as the reference data, resuming the battery discharging; or
in response to determining that the comparison result indicates that the metric of measured voltage change is different from the reference data, terminating the battery discharging.

18. The method of claim 16, wherein the battery discharging device comprises a memory to store results of the measurements of the voltage and energy of the battery.

19. The method of claim 16, wherein the one or more criteria are defined based on percentages of discharged energy from the initial energy of the battery.

20. The method of claim 16, wherein the reference data is updated based on temperature and/or humidity.
